(19) United States
(12) Patent Application Publication
(10) Pub. No.: US 2026/0224978 A1
(43) Pub. Date: Aug. 6, 2026

(54) GAME BLOCKS FOR KEYBOARD

(71) Applicant: Lenovo (United States) Inc., Morrisville, NC (US)

(72) Inventors: Jujuan Mitchell, Raleigh, NC (US); Christopher Osborne, Cary, NC (US); Ada Lopez, Raleigh, NC (US); Katrina Andrews, Apex, NC (US); Brian Lee, Raleigh, NC (US); Dana Cockrum Gierdowski, Raleigh, NC (US); Matthew Horn, Cary, NC (US); Brian Richardson, Columbus, GA (US)

(21) Appl. No.: 19/047,505

(22) Filed: Feb. 6, 2025

(51) Int. Cl. A63F 13/245; A63F 13/42

(52) U.S. Cl. CPC A63F 13/245; A63F 13/42

(57) ABSTRACT

A keyboard has multiple keys configured for entering data and includes a first game block coupled to a first set of the keys of the keyboard. A second game block is coupled to a second set of the keys of the keyboard including only keys different from any of the keys of the first set of keys. The first game block is configured to actuate each of the first set of keys in response to pressing the first game block while fit over the first set of keys. The second game block is configured to actuate each of the second set of keys in response to pressing the second game block while fit over the second set of keys.

### BACKGROUND

Common keyboards generally have a large number of keys corresponding to different characters. A qwerty keyboard has keys for English language letters that are sized to accommodate the use of fingers to activate them. When such keyboards are used for gaming, it can be difficult for some users to accurately hit different keys assigned to different gaming functions, especially when the user is deeply involved in a game requiring rapid selection of different functions.

To alleviate such difficulties, specialized gaming input devices have been designed with buttons that are larger than typical keys to provide a better user interface. However, some gaming users still use standard keyboards for gaming, which can adversely affect the user's game performance.

### SUMMARY

A keyboard has multiple keys configured for entering data and includes a first game block coupled to a first set of the keys of the keyboard. A second game block is coupled to a second set of the keys of the keyboard including only keys different from any of the keys of the first set of keys. The first game block is configured to actuate each of the first set of keys in response to pressing the first game block while fitting over the first set of keys. The second game block is configured to actuate each of the second set of keys in response to pressing the second game block while fitting over the second set of keys. Actuation of the sets of keys may identify a function to be executed.

### BRIEF DESCRIPTION OF THE DRAWINGS

FIG. 1 is a block diagram illustrating a keyboard having multiple game blocks according to an example embodiment.

FIG. 2 is a cross section of an example game block according to an example embodiment.

FIG. 3 is a cross section of an alternative example game block according to an example embodiment.

FIG. 4 is a block diagram of a gaming system according to an example embodiment.

FIG. 5 is a flowchart illustrating a method of mapping keys of a section of keys covered by a game block to provide a signal representative of a single key within the section of keys according to an example embodiment.

FIG. 6 is a block schematic diagram of a computer system to implement one or more example embodiments.

### DETAILED DESCRIPTION

In the following description, reference is made to the accompanying drawings that form a part hereof, and in which are shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Users may have difficulty efficiently using keyboards designed for data entry, such as qwerty keyboards, while playing video games. Qwerty keyboard and other keyboards designed for typing generally have small keys to fit them in a space designed to accommodate touch typing. Users with dexterity issues may have an even more difficult time using a keyboard for gaming, especially in games requiring the use of different functions which are each usually assigned to a specific key. Many game users (gamers) use their thumbs for selecting game functions when using gaming input devices. The use of thumbs on keyboards is basically used for hitting a spacebar and not for hitting individual character entry keys.

To improve user interaction with a keyboard for game play, multiple keyboard caps, referred to as game blocks, may be placed over different selected sections of multiple keys on a keyboard. The game blocks provide larger surfaces for gaming interaction. Each game block may be mapped to a particular interaction with a game, such as different movement functions or actions, depending on the game. Pressing one of the game blocks is interpreted as selecting the mapped interaction.

While the keyboard caps are referred to as game blocks, such game blocks may be used in other than gaming environments in further examples, such as art related applications.

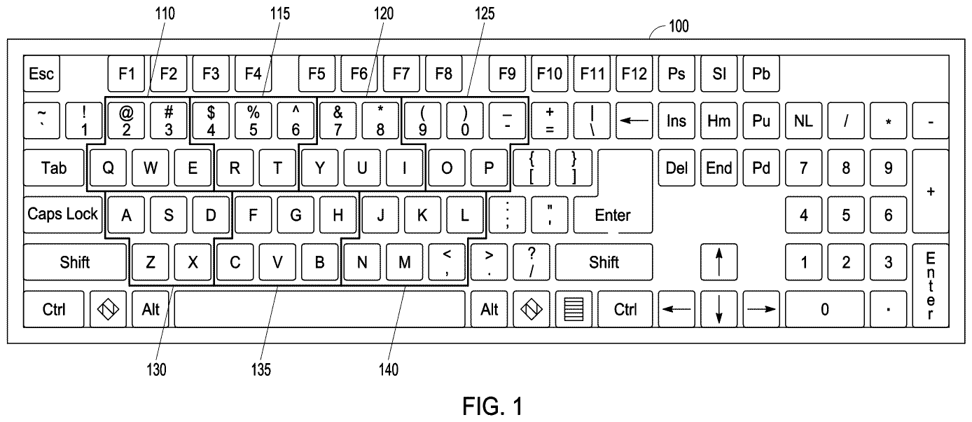

FIG. 1 is a block diagram illustrating a keyboard 100 having multiple game blocks 110, 115, 120, 125, 130, 135, and 140 placed over different sections or sets of keys. Keyboard 100 is a qwerty keyboard having English letters placed in three rows. A top row comprises the letters qwertyuiop. A middle row comprises the letters asdfghjkl, and a bottom row comprises the letters zxcvbnm. Other characters and keys include shift keys, space bar, tab key, enter key, numbers, cursor control keys, function keys, and others commonly found on computer keyboards.

The game blocks in one example are designed to cover keys according to the following Table 1:
Game block Keys
Game block 110 à 23qwe
Game block 115 à0 456rt
Game block 120 à 78yu
Game block 125 à 90-iop
Game block 130 à asdzx
Game block 135 à fghcvb
Game block 140 à jklnm.

While this particular arrangement and configuration of game blocks may be suitable for one game, it may be modified for different games to better fit anticipated user interactions with each game. Some games may have fewer or more functions to select and therefore may be better interacted with using a different number of and configuration of game blocks.

Pressing game block 110 results in pressing or actuating each of the 23qwe keys at the same time. Keyboard 100 may accommodate simultaneous key presses in different ways. In one example, the keyboard may select to provide a signal to gaming software representative of the strongest signal from the multiple key actuations. In such cases, the gaming software may include a mapping function to map a selected function to each of the keys covered by game block 100. In further examples, the keyboard 100 may be configured to ignore actuation of all but one key covered by game block 100. The one key is selected to be the key corresponding to the desired function of the game.

Pressing of the other game blocks 115, 120, 125, 130, 135, and 140 each actuate one or more keys that are respectively covered and mapped to different functions of the game in the same manner as game block 110.

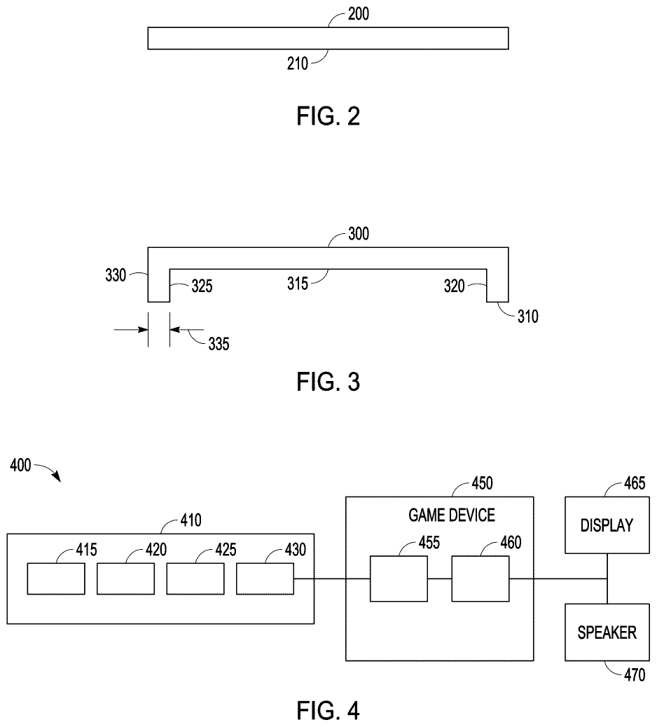

FIG. 2 is a cross section of an example game block 200. Game block 200 may be formed of plastic or other material suitable for pressing and actuating a section of keys that it covers when placed on a keyboard. In one example, the game block 200 is a rigid material that is flat and may be placed directly on top of the desired section of keys, such as keys 23qwe on a qwerty keyboard. A bottom surface 210 that contacts the keys may have a tacky substance to remain in place over the keys during use of the game block 200 during game play. The use of a tacky surface on the bottom surface 210 enables pressing of keys that are designed to be flush with a top surface of the keyboard when pressed.

FIG. 3 is a cross section of an alternative example game block 300. Game block 300 may be formed of plastic or other material suitable for pressing a section of keys that it covers when placed on a keyboard. In one example, the game block 300 is a rigid material that is flat and may be placed directly on top of the desired section of keys, such as keys 23qwe on a qwerty keyboard. A ridge 310 may be formed around a perimeter of the game block 300 and extends away from a bottom surface 315 of the game block that contacts the keys.

The ridge 310 may have a vertical length 320 designed to enable pressing and actuation of the keys by the bottom surface 315 during use of the game block 300 during game play. The use of the ridge 310 enables pressing of keys that when actuated still extend above the keyboard surface a sufficient distance that is equal to or greater than the length 320 of the ridge 310. An inner surface 325 of the ridge 310 around the perimeter should fit closely to a corresponding outside perimeter of the desired section of keys to help hold the game block 300 in place during play. An outer surface 330 of the ridge 310 should extend a lateral width 335 that is less than the distance to adjacent keys outside the game block 300 to accommodate an adjacent game block. The bottom surface 315 may also have a tacky substance to help hold the game block 300 in place.

FIG. 4 is a block diagram of a gaming system 400. Gaming system 400 includes a keyboard 410 having multiple game blocks 415, 420, and 425 corresponding to different sections of keys of the keyboard 410. Keyboard 410 includes keyboard processing circuitry 430 to detect key presses and provide signals 435 [NOT LABELED—omit or label?] corresponding to such key presses to a game device 450.

Game device 450 includes game processing circuitry 455 to receive the signals 435 from the keyboard 410 and interpret such signals as selection of game functions corresponding to pressed game blocks. Processing circuitry 455 may also include a gaming processor 460 to execute selected game functions and provide the user experience via a display 465 and speaker 470.

Each key of the keyboard may be associated with a digital to analog converter to enable the keyboard to recognize simultaneous key actuations and process them together.

In one example, keyboard processing circuitry 430 may suppress keys within a section of keys corresponding to a game block, other than a selected key that is assigned to a game function. The keyboard processing circuitry 430 then provides signals 435 representing actuation of the selected key in response to pressing of the game block.

In a further example, the keyboard processing circuitry 430 may receive signals from multiple or all of the section of keys corresponding to a game block and select a strongest signal or a largest integration of signals from the multiple keys. The keyboard processing circuitry 430 may generate signals 435 representative of the strongest, largest integration, or all of the signals to the game processing circuitry 455, which will then select the appropriate function to execute. The game processing circuitry 455 may be configured to accept any key of the corresponding section of keys as representative of the function, such as by using a macro function to assign multiple keys to a function or otherwise mapping each of the section of keys to the same function.

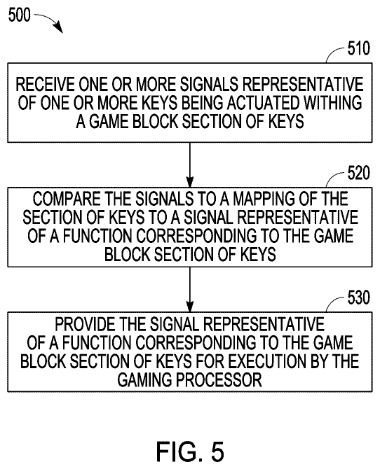

FIG. 5 is a flowchart illustrating a method 500 of mapping keys of a section of keys to provide a signal representative of a single key within the section of keys. Method 500 may be implemented either in the keyboard processing circuitry 430 or the game processing circuitry 455. Method 500 begins at operation 510 by receiving one or more signals representative of one or more keys being actuated withing a game block section of keys. Operation 520 compares the signals to a mapping of the section of keys to a signal representative of a function corresponding to the game block section of keys. Operation 530 then provides the signal representative of a function corresponding to the game block section of keys for execution by the gaming processor 460.

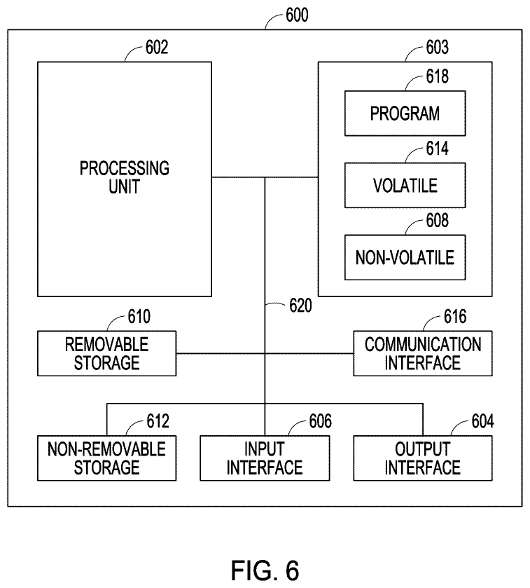

FIG. 6 is a block schematic diagram of a computer system 600 to . . . And for performing methods and algorithms according to example embodiments. All components need not be used in various embodiments.

One example computing device in the form of a computer 600 may include a processing unit 602, memory 603, removable storage 610, and non-removable storage 612. Although the example computing device is illustrated and described as computer 600, the computing device may be in different forms in different embodiments. For example, the computing device may instead be a smartphone, a tablet, smartwatch, smart storage device (SSD), or other computing device including the same or similar elements as illustrated and described regarding FIG. 6. Devices, such as smartphones, tablets, and smartwatches, are generally collectively referred to as mobile devices or user equipment.

Although the various data storage elements are illustrated as part of the computer 600, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 600 may include or have access to a computing environment that includes input interface 606, output interface 604, and a communication interface 616. Output interface 604 may include a display device, such as a touchscreen, that also may serve as an input device. The input interface 606 may include one or more of a touchscreen, touchpad, mouse, keyboard, camera, one or more device-specific buttons, one or more sensors integrated within or coupled via wired or wireless data connections to the computer 600, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 600 are connected with a system bus 620.

Computer-readable instructions stored on a computer-readable medium are executable by the processing unit 602 of the computer 600, such as a program 618. The program 618 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 618 may be used to cause processing unit 602 to perform one or more methods or algorithms described herein.

### EXAMPLES

1. A keyboard has multiple keys configured for entering data and includes a first game block coupled to a first set of the keys of the keyboard. A second game block is coupled to a second set of the keys of the keyboard including only keys different from any of the keys of the first set of keys. The first game block is configured to actuate each of the first set of keys in response to pressing the first game block while fit over the first set of keys. The second game block is configured to actuate each of the second set of keys in response to pressing the second game block while fit over the second set of keys.
2. The device of example 1 wherein the first game block and the second game block have respective perimeters extending at least to outer edges of keys in the first set of keys.
3. The device of any of examples 1-2 wherein the first game block and the second game block each include a bottom side comprising a tacky surface configured to contact the respective keys of the first set of keys and the second set of keys.
4. The device of any of examples 1-3 wherein the first game block and the second game block have respective perimeters having ridges extending downward from a bottom surface of the respective first game block and second game block, wherein ridges are positioned to fit over the respective first set of keys and the second set of keys.
5. The device of example 4 wherein the ridges have a lateral thickness that extends less than halfway to keys adjacent to the respective first set of keys and the second set of keys.
6. The device of example 5 wherein the ridges have a ridge length extending from the respective bottom surfaces that permits actuation of the respective sets of keys without contacting a top surface of the keyboard prior to actuation.
7. The device of example 5 wherein the first game block and the second game block each include a bottom side comprising a tacky surface configured to contact the respective keys of the first set of keys and the second set of keys.
8. The device of any of examples 1-7 wherein the keyboard comprises keyboard processing circuitry configured to provide signals representative of pressed game blocks.
9. The device of example 8 wherein the keyboard processing circuitry is configured to provide signals representative of one key mapped to a game function from each set of keys in response to a respective game block being depressed.
10. The device of any of examples 8-9 and further including a game device coupled to receive the signals representative of pressed game blocks. The game device includes game processing circuitry to identify a game function from each signal representative of a pressed game block and processing circuitry to execute the game function.
11. A method includes selecting a first set of keys of a keyboard and placing a first game block over the first set of keys. The method includes selecting a second set of keys of the keyboard, all of which are different from the first set of keys, placing a second game block over the second set of keys, receiving a first signal in response to pressing of the first game block, and providing the first signal to a game device for execution of a first game function mapped to at least one of the keys of the first set of keys.
12. The method of example 11 wherein the first signal is mapped to a first key of the first set of keys.
13. The method of example 12 wherein the first signal comprises multiple signals representative of actuation of all the keys of the first set of keys.
14. The method of example 13 wherein the multiple signals are mapped to the first key by keyboard processing circuitry based on at least one of the multiple signals corresponding to actuation of any one of the first set of keys.
15. The method of any of examples 11-14 and further including receiving a second signal in response to pressing of the second game block and providing the second signal to a game device for execution of a second game function mapped to at least one of the keys of the second set of keys.
16. The method of any of examples 14-15 wherein the second signal comprises multiple signals representative of actuation of all the keys of the second set of keys and that is mapped to the second key by the game device.
17. The method of example 16 wherein the multiple signals are mapped to the first key by game processing circuitry of the game device based on at least one of the multiple signals corresponding to actuation of any one of the first set of keys.
18. The method of any of examples 11-17 wherein placing a first game block over the first set of keys comprises coupling the first game block to the first set of keys and placing the second game block over the second set of keys comprises coupling the second game block to second first set of keys.
19. The method of any of examples 11-17 wherein placing a first game block over the first set of keys comprises positioning a first perimeter ridge of the first game block over outside edges of the first set of keys and wherein placing the second game block over the second set of keys comprises positioning a second perimeter ridge of the second game block over outside edges of the second set of keys.
20. The method of example 19 wherein the first perimeter ridge and the second perimeter ridge have widths that do not exceed half a distance to adjacent keys.
21. A device includes a first game block configured to fit over a first set of keys of a keyboard, a second game block configured to fit over a second set of keys of a keyboard including only keys different from any of the keys of the first set of keys, wherein the first game block is configured to actuate each of the first set of keys in response to pressing the first game block while fit over the first set of keys, and wherein the second game block is configured to actuate each of the second set of keys in response to pressing the second game block while fit over the second set of keys.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server, or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using software, hardware, firmware, or the like. The terms “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term “processor” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term “article of manufacture” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A device comprising:
a keyboard having multiple keys configured for entering data;
a first game block coupled to a first set of the keys of the keyboard;
a second game block coupled to a second set of the keys of the keyboard including only keys different from any of the keys of the first set of keys;
wherein the first game block is configured to actuate each of the first set of keys in response to pressing the first game block while fit over the first set of keys; and
wherein the second game block is configured to actuate each of the second set of keys in response to pressing the second game block while fit over the second set of keys.

2. The device of claim 1 wherein the first game block and the second game block have respective perimeters extending at least to outer edges of keys in the first set of keys.

3. The device of claim 2 wherein the first game block and the second game block each include a bottom side comprising a tacky surface configured to contact the respective keys of the first set of keys and the second set of keys.

4. The device of claim 3 wherein the first game block and the second game block have respective perimeters having ridges extending downward from a bottom surface of the respective first game block and second game block, wherein ridges are positioned to fit over the respective first set of keys and the second set of keys.

5. The device of claim 4 wherein the ridges have a lateral thickness that extends less than halfway to keys adjacent to the respective first set of keys and the second set of keys.

6. The device of claim 5 wherein the ridges have a ridge length extending from the respective bottom surfaces that permits actuation of the respective sets of keys without contacting a top surface of the keyboard prior to actuation.

7. The device of claim 6 wherein the first game block and the second game block each include a bottom side comprising a tacky surface configured to contact the respective keys of the first set of keys and the second set of keys.

8. The device of claim 7 wherein the keyboard comprises keyboard processing circuitry configured to provide signals representative of pressed game blocks.

9. The device of claim 8 wherein the keyboard processing circuitry is configured to provide signals representative of one key mapped to a game function from each set of keys in response to a respective game block being depressed.

10. The device of claim 9 and further comprising:
a game device coupled to receive the signals representative of pressed game blocks, the game device including:
game processing circuitry to identify a game function from each signal representative of a pressed game block; and
processing circuitry to execute the game function.

11. A method comprising:
selecting a first set of keys of a keyboard;
placing a first game block over the first set of keys;
selecting a second set of keys of the keyboard all of which are different from the first set of keys;
placing a second game block over the second set of keys;
receiving a first signal in response to pressing of the first game block; and
providing the first signal to a game device for execution of a first game function mapped to at least one of the keys of the first set of keys.

12. The method of claim 11 wherein the first signal is mapped to a first key of the first set of keys.

13. The method of claim 12 wherein the first signal comprises multiple signals representative of actuation of all the keys of the first set of keys.

14. The method of claim 13 wherein the multiple signals are mapped to the first key by keyboard processing circuitry based on at least one of the multiple signals corresponding to actuation of any one of the first set of keys.

15. The method of claim 14and further comprising:
receiving a second signal in response to pressing of the second game block; and
providing the second signal to a game device for execution of a second game function mapped to at least one of the keys of the second set of keys.

16. The method of claim 15 wherein the second signal comprises multiple signals representative of actuation of all the keys of the second set of keys and that is mapped to the second key by the game device.

17. The method of claim 16 wherein the multiple signals are mapped to the first key by game processing circuitry of the game device based on at least one of the multiple signals corresponding to actuation of any one of the first set of keys.

18. The method of claim 17 wherein placing a first game block over the first set of keys comprises coupling the first game block to the first set of keys and placing the second game block over the second set of keys comprises coupling the second game block to second set of keys.

19. The method of claim 18 wherein placing a first game block over the first set of keys comprises positioning a first perimeter ridge of the first game block over outside edges of the first set of keys and wherein placing the second game block over the second set of keys comprises positioning a second perimeter ridge of the second game block over outside edges of the second set of keys.

20. The method of claim 19 wherein the first perimeter ridge and the second perimeter ridge have widths that do not exceed half a distance to adjacent keys.
